(19) United States
(12) Patent Application Publication
(10) Pub. No.: US 2017/0115845 A1
(43) Pub. Date: Apr. 27, 2017

(54) SMART DIGITAL SHOWCASE

(71) Applicant: SQI Soft, Seoul (KR)

(72) Inventors: Sang Hoon SHIN, Seoul (KR); Jun Ho LIM, Seoul (KR); Gyu Cheol SHIN, Incheon (KR); Seon Gyeon PARK, Seoul (KR); Mi Seok JEONG, Bucheon-si (KR)

(21) Appl. No.: 15/331,325

(22) Filed: Oct. 21, 2016

(30) Foreign Application Priority Data
Oct. 23, 2015 (KR) 10-2015-0147973

(51) Int. Cl. G06F 3/0488; A47F 3/00; A47F 11/06; G06F 3/0484

(52) U.S. Cl. CPC G06F 3/0488; G06F 3/04845; A47F 3/007; A47F 11/06; G06F 3/04817

(57) ABSTRACT

There is provided an electronic showcase comprising: a main body having an lower plate and an upper plate, whether the main body has an inner space defined between the lower plate and upper plate, wherein the upper plate is transparent, wherein the upper plate includes a transparent touch-recognition panel, wherein the lower plate has a plurality of goods or goods group regions, wherein the transparent touch-recognition panel has a plurality of touch-sensing regions vertically position-corresponding to the plurality of goods or goods group regions respectively; and a display unit configured to display an image of and/or information about single goods or goods group corresponding to a goods or goods group region selected by a touch of a corresponding touch-sensing region.

### CROSS-REFERENCE TO RELATED APPLICATION

This application claims the benefit of Korea patent application No. 10-2015-0147973 filed on Oct. 23, 2015, the entire content of which is incorporated herein by reference for all purposes as if fully set forth herein.

### BACKGROUND

Field of the Present Disclosure

The present disclosure relates to an electronic showcase, and, more particularly, to an electronic showcase to electronically display information about displayed goods.

Discussion of Related Art

In general, a conventional showcase that can safely exhibit jewelry, luxury goods and other high-priced goods has a structure having a glass plate on each side so that the inside can be seen from the outside. One side can be opened. Such a conventional showcase has locking means such that the goods is kept safely as it displays expensive goods.

To replace the goods that were displayed in the showcase, the user should open the inside by releasing the lock device. Since replacing the goods is not done frequently, opening of the showcase it not troublesome.

However, when multiple consumers who want to purchase goods on the showcase request the goods to be withdrawn from the showcase to examine the goods, the showcase is frequently opened. This is very cumbersome. In addition, there is a problem that it is inconvenient for the consumer to request withdrawal of goods.

Further, in displaying goods, it is necessary to display information tags such as price tags and name tags, etc. together with goods. This is very cumbersome.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure is to provide an electronic showcase to provide detailed information about the goods without withdrawing the goods from the inner space in the showcase. Thus, only when the consumer decides to buy the goods, the showcase is open. Thus, the goods in the showcase may be safely kept.

In one aspect of the present disclosure, there is provided an electronic showcase comprising: a main body having an lower plate and an upper plate, whether the main body has an inner space defined between the lower plate and upper plate, wherein the upper plate is transparent, wherein the upper plate includes a transparent touch-recognition panel, wherein the lower plate has a plurality of goods or goods group regions, wherein the transparent touch-recognition panel has a plurality of touch-sensing regions vertically position-corresponding to the plurality of goods or goods group regions respectively; and a display unit configured to display an image of and/or information about single goods or goods group corresponding to a goods or goods group region selected by a touch of a corresponding touch-sensing region.

In one implementation, the display unit is disposed on the upper plate in a parallel or tilted manner to the upper plate or around the upper plate.

In one implementation, the display unit includes a touch sensing screen. In one implementation, the display unit has a storage to store data about the goods or goods groups disposed on the plurality of goods or goods group regions.

In one implementation, the touch sensing screen is configured to display further information about the selected single goods or goods group when a portion of the touch sensing screen corresponding to the selected goods or goods group is touched.

In one implementation, the display unit is disposed on the lower plate.

In one implementation, the touch-recognition panel is divided into a goods arrangement area and a display unit area, wherein the goods arrangement area vertically position-corresponds to the plurality of goods or goods group regions, wherein the display unit area vertically position-corresponds to the display unit disposed on the lower plate, wherein the goods arrangement area includes the plurality of touch-sensing regions.

In one implementation, the display unit has a storage to store data about the goods or goods groups disposed on the plurality of goods or goods group regions.

In one implementation, the display unit is configured to display further information about the selected single goods or goods group when a portion of the display unit area corresponding to the selected single goods or goods group is touched.

In one implementation, the display unit includes a view rotation module to rotate a view image on the display unit.

In one implementation, the touch-recognition panel includes a view rotation module to rotate a view image on the display unit.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a perspective view of an electronic showcase in accordance with a first embodiment of the present disclosure.

FIG. 2 is a cross-sectional view of an upper plate in FIG. 1.

FIG. 3a to FIG. 3c illustrate various arrangements of the touch regions.

FIG. 4 illustrates one example of displayed image and information on the display unit.

FIG. 5 is a perspective view of an electronic showcase in accordance with a second embodiment of the present disclosure.

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

### First Embodiment

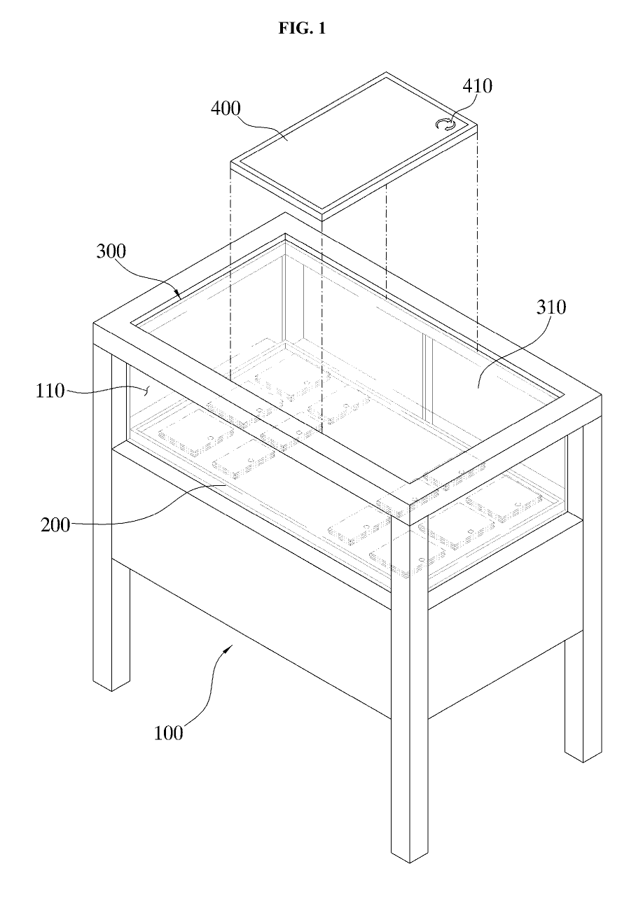

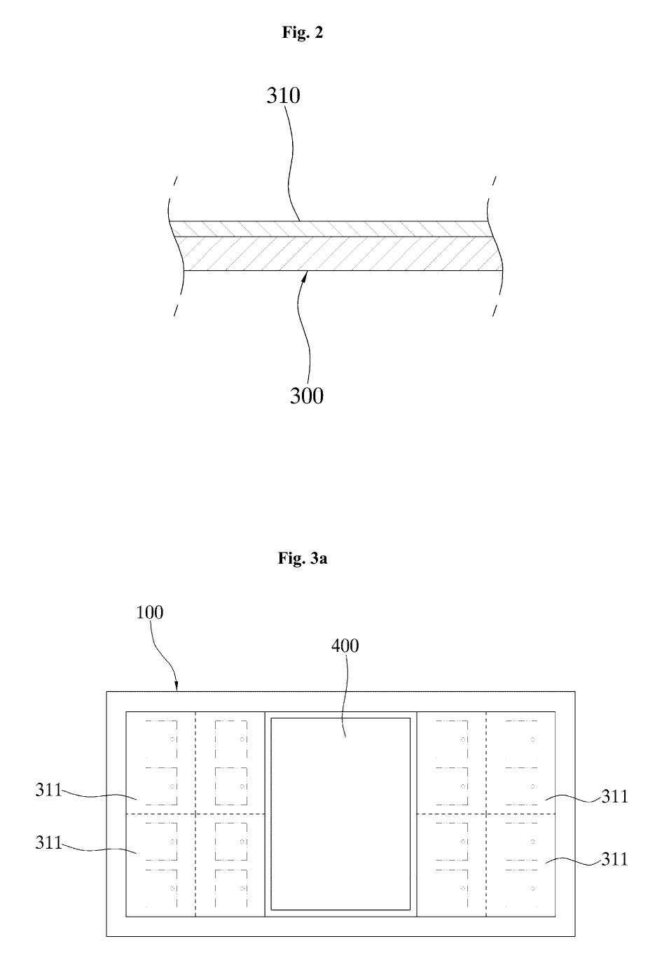

FIG. 1 is a perspective view of an electronic showcase in accordance with a first embodiment of the present disclosure. FIG. 2 is a cross-sectional view of an upper plate in FIG. 1.

Referring to FIG. 1, an electronic showcase in accordance with a first embodiment of the present disclosure may include an electronic showcase body 100 having an inner space 110, a lower plate 200, a upper plate 300, and display unit 400.

The lower plate 200 and upper plate 300 may define the inner space 110 therebetween. For example, the lower plate 200 may be integrated with the body 100 or may be removed from the body 100 to be inserted into or withdrawn from the inner space 110. On the lower plate 200, multiple goods may be disposed. The lower plate 200 is not limited particularly in terms of a shape. For example, a rectangular shape may be available. The multiple goods on the lower plate 200 may be arranged on a group basis. The goods on the lower plate 200 are not limited particularly in terms of types. For example, the goods on the lower plate 200 may be watches, wallets, jewelries, etc.

The upper plate 300 may be spaced from the lower plate 200 to define the inner space 110 therebetween. The upper plate 300 may be light-transparent to allow the goods on the lower plate 200 to be visible. For example, the upper plate 300 may made of a transparent glass.

The upper plate 300 may include a touch-recognition panel 310 disposed thereon. The touch-recognition panel 310 may include, for example, a touch screen to sense touch of a hand or touch pen, stylist, etc. The touch-recognition panel 310 is not limited particularly in terms of a touch sensing scheme. For example, the touch sensing scheme may include a resistive, capacitive, infrared grid, acoustic pulse recognition, or dispersive signal technologies. The touch-recognition panel 310 may be disposed on the upper plate 300 as shown in FIG. 2. The touch-recognition panel 310 may detect a touch and generate a signal corresponding to the touch and send the signal to the display unit 400. Thus, the touch-recognition panel 310 may connected to the display unit 400.

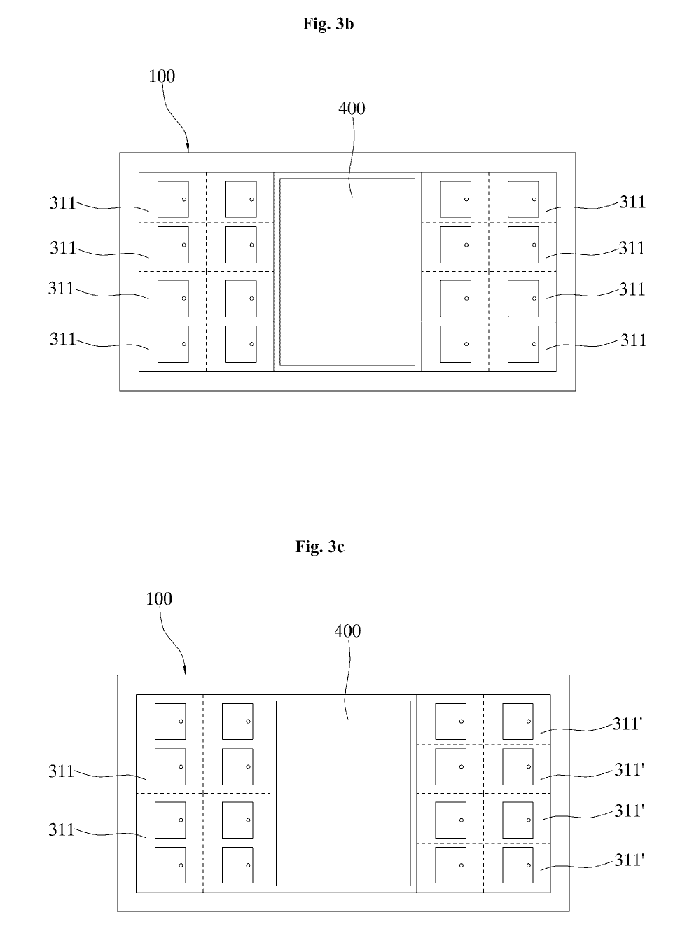

In one embodiment, the touch-recognition panel 310 may be divided into multiple regions 311. The touch regions 311 each may have a predetermined area. FIG. 3a to FIG. 3c illustrate various arrangements of the touch regions.

In one embodiment, as shown in FIG. 3a, each touch region 311 may correspond to a group of at least two goods. In this connection, a group of at least two goods may be selected upon touching a corresponding touch region 311.

In another embodiment, each touch region 311 may correspond to single goods. In this connection, the single goods may be selected upon touching a corresponding touch region 311. This is shown in FIG. 3b.

In still another embodiment, each of some touch regions 311′ may correspond to single goods, while each of the other touch regions 311 may correspond to a group of at least two goods. This is a combination of the arrangements of FIG. 3a and FIG. 3b. This is shown in FIG. 3c.

The display unit 400 may be configured to display information on a goods group or single goods selected by touch of a corresponding touch region of the touch-recognition panel 310. To be specific, when the user touches a corresponding touch region 311 or 311′ of the touch-recognition panel 310 to a goods group or single goods, the display unit 400 may display information about the goods group or single goods selected by the touch of the corresponding touch region 311 or 311′ of the touch-recognition panel 310. In this connection, the goods group or single goods may be visible through the upper plate 300. For this, the touch-recognition panel 310 may be implemented using a transparent touch screen.

The display unit 400 may be parallel to the upper plate 300. Alternatively, the display unit 400 may stand upright or in a tilted manner on or to the upper plate 300. The tilt angle may be not limited particularly. In this connection, the display unit 400 may be implemented by a touch screen. The display unit 400 may be configured to first display an image of the goods group or single goods selected by the touch of the corresponding touch region 311 or 311′ of the touch-recognition panel 310 and to then display information about the goods group or single goods when the user may touch the goods group or single goods on the touch screen as the display unit. In this connection, the goods group or single goods may be visible through the upper plate 300. For this, the touch-recognition panel 310 may be implemented using a transparent touch screen. The display unit 400 may implemented using a conventional non-transparent touch screen.

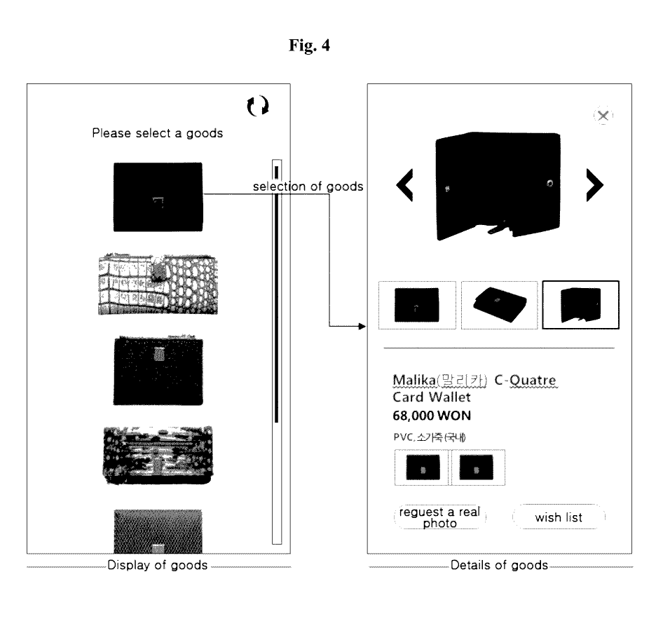

Hereinafter, an operation of the electronic showcase in accordance with the first embodiment will be described in details. FIG. 4 illustrates one example of displayed image and information on the display unit.

The user may touch a touch region 311 in the touch-recognition panel 310 vertically position-corresponding to a target goods group or single goods on the lower plate 200. The touch-recognition panel 310 senses the touch of the touch region 311. Then, the display unit 400 may display an image of the goods group or single goods. For example, as shown in FIG. 4 to the left thereof, the goods group may be displayed in an arranged manner.

Then, the user may touch one target goods on the touch screen as the display unit 400, the display unit 400 may display detailed information about the target goods. This is shown in FIG. 4 to the right thereof.

In this way, the user may check detailed information about the target goods without manually withdrawing the target goods out of the inner space 110.

In one embodiment, the display unit 400 for the electronic showcase may include a view rotation menu 410. The view rotation menu 410 may be displayed as one icon on the touch screen as the display unit 400. The user may touch the view rotation menu 410 to allow a rotation of the view image of the goods. For example, upon each touch of the view rotation menu 410, the goods image may rotate by 45 degree in a counter-wise or anti-counter-wise direction.

### Embodiment 2

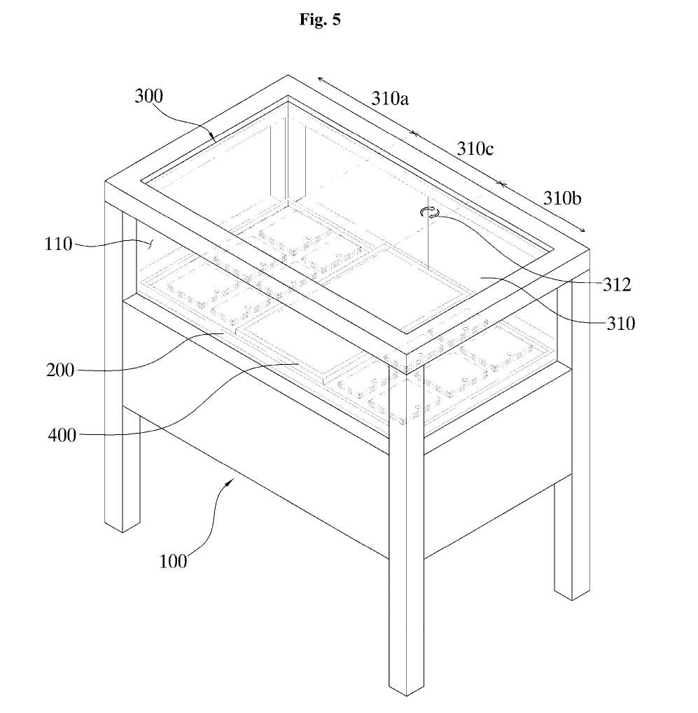

FIG. 5 is a perspective view of an electronic showcase in accordance with a second embodiment of the present disclosure. FIG. 2 is a cross-sectional view of an upper plate in FIG. 5.

Referring to FIG. 5, an electronic showcase in accordance with the second embodiment of the present disclosure may include an electronic showcase body 100 having an inner space 110, a lower plate 200, an upper plate 300, and display unit 400.

The lower plate 200 and upper plate 300 may define the inner space 110 therebetween. For example, the lower plate 200 may be integrated with the body 100 or may be removed from the body 100 to be inserted into or withdrawn from the inner space 110. On the lower plate 200, multiple goods may be disposed. The lower plate 200 is not limited particularly in terms of a shape. For example, a rectangular shape may be available. The multiple goods on the lower plate 200 may be arranged on a group basis. The goods on the lower plate 200 are not limited particularly in terms of types. For example, the goods on the lower plate 200 may be watches, wallets, jewelries, etc.

The upper plate 300 may be spaced from the lower plate 200 to define the inner space 110 therebetween. The upper plate 300 may be light-transparent to allow the goods on the lower plate 200 to be visible. For example, the upper plate 300 may made of a transparent glass.

The upper plate 300 may include a transparent touch-recognition panel 310 disposed thereon. The touch-recognition panel 310 may include, for example, a touch screen to sense touch of a hand or touch pen, stylist, etc. The touch-recognition panel 310 is not limited particularly in terms of a touch sensing scheme. For example, the touch sensing scheme may include a resistive, capacitive, infrared grid, acoustic pulse recognition, or dispersive signal technologies. The touch-recognition panel 310 may be disposed on the upper plate 300 as shown in FIG. 2. The touch-recognition panel 310 may detect a touch and generate a signal corresponding to the touch and send the signal to the display unit 400. Thus, the touch-recognition panel 310 may connected to the display unit 400.

In this embodiment, the display unit 400 may be disposed on the lower plate 200. In this connection, the touch-recognition panel 310 may be divided into three transparent regions 310a, 310b and 310c. To be specific, the three transparent regions 310a, 310b and 310c may correspond to a first goods arrangement region, a display unit region, and a second goods arrangement region.

The first and second transparent regions 310a and/or 310a may have various arrangements of touch regions 311 therein as shown in FIG. 3a to FIG. 3c. In one embodiment, as shown in FIG. 3a, each touch region 311 may correspond to a group of at least two goods. In this connection, a group of at least two goods may be selected upon touching a corresponding touch region 311. In another embodiment, each touch region 311 may correspond to single goods. In this connection, the single goods may be selected upon touching a corresponding touch region 311. This is shown in FIG. 3b. In still another embodiment, each of some touch regions 311′ may correspond to single goods, while each of the other touch regions 311 may correspond to a group of at least two goods. This is a combination of the arrangements of FIG. 3a and FIG. 3b. This is shown in FIG. 3c.

The display unit 400 may be disposed on the lower plate 200. The display unit 400 may be configured to display information on a goods group or single goods selected by touch of a corresponding touch region of the touch-recognition panel 310. To be specific, when the user touches a corresponding touch region 311 or 311′ of the touch-recognition panel 310 to a goods group or single goods, the display unit 400 may display information about the goods group or single goods selected by the touch of the corresponding touch region 311 or 311′ of the touch-recognition panel 310. In this connection, the goods group or single goods may be visible through the upper plate 300. For this, the touch-recognition panel 310 may be implemented using a transparent touch screen.

The touch-recognition panel is divided into a goods arrangement area 310a or 310c and a display unit area 310b, wherein the goods arrangement area vertically position-corresponds to the plurality of goods or goods group regions, wherein the display unit area 310b vertically position-corresponds to the display unit 400 disposed on the lower plate 200, wherein the goods arrangement area 310a or 310c includes the plurality of touch-sensing regions 311 or 3111.

The display unit has a storage (not shown) to store data about the goods or goods groups disposed on the plurality of goods or goods group regions.

The display unit 400 may be configured to display further information about the selected single goods or goods group when a portion of the display unit area 310-b corresponding to the selected single goods or goods group is touched.

Hereinafter, an operation of the electronic showcase in accordance with the second embodiment will be described in details. FIG. 4 illustrates one example of displayed image and information on the display unit.

The user may touch a touch region 311 in the touch-recognition panel 310 on the upper plate 300 vertically position-corresponding to a target goods group or single goods on the lower plate 200. The touch-recognition panel 310 senses the touch of the touch region 311. Then, the display unit 400 disposed on the lower plate 200 may display an image of the goods group or single goods thereon. For example, as shown in FIG. 4 to the left thereof, the goods group may be displayed in an arranged manner.

Then, when the user may touch a portion of the display unit area 310-b corresponding to the selected single goods or goods group, the display unit 400 may display further information about the selected single goods or goods group. This is shown in FIG. 4 to the right thereof.

In this way, the user may check detailed information about the target goods without manually withdrawing the target goods out of the inner space 110. Further, since the display unit 400 is received in the inner space 110, the display unit 400 may be protected from an external damage.

In one embodiment, the touch recognition panel 310 for the electronic showcase may include a view rotation menu 312. The view rotation menu 312 may be displayed as one icon on the touch recognition panel 310. The user may touch the view rotation menu 312 to allow a rotation of the view image of the goods on the display unit 400. For example, upon each touch of the view rotation menu 312, the goods image may rotate by 45 degree in a counter-wise or anti-counter-wise direction on the display unit 400.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. An electronic showcase comprising:
a main body having an lower plate and an upper plate, whether the main body has an inner space defined between the lower plate and upper plate, wherein the upper plate is transparent, wherein the upper plate includes a transparent touch-recognition panel, wherein the lower plate has a plurality of goods or goods group regions, wherein the transparent touch-recognition panel has a plurality of touch-sensing regions vertically position-corresponding to the plurality of goods or goods group regions respectively; and a display unit configured to display an image of and/or information about single goods or goods group corresponding to a goods or goods group region selected by a touch of a corresponding touch-sensing region.

2. The showcase of claim 1, wherein the display unit is disposed on the upper plate in a parallel or tilted manner to the upper plate or around the upper plate, wherein the display unit includes a touch sensing screen, wherein the touch sensing screen is configured to display further information about the selected single goods or goods group when a portion of the touch sensing screen corresponding to the selected goods or goods group is touched.

3. The showcase of claim 1, wherein the display unit is disposed on the lower plate, wherein the touch-recognition panel is divided into a goods arrangement area and a display unit area, wherein the goods arrangement area vertically position-corresponds to the plurality of goods or goods group regions, wherein the display unit area vertically position-corresponds to the display unit disposed on the lower plate, wherein the goods arrangement area includes the plurality of touch-sensing regions, wherein the display unit is configured to display further information about the selected single goods or goods group when a portion of the display unit area corresponding to the selected single goods or goods group is touched.

4. The showcase of claim 2, wherein the display unit includes a view rotation module to rotate a view image on the display unit.

5. The showcase of claim 3, wherein the touch-recognition panel includes a view rotation module to rotate a view image on the display unit.
